(19) United States
(12) Patent Application Publication
(10) Pub. No.: US 2003/0149574 A1
(43) Pub. Date: Aug. 7, 2003

(54) Method for providing media consumers with total choice and total control

(76) Inventor: Daniel E. Rudman, Waterford, MI (US)

Correspondence Address: HARNESS, DICKEY & PIERCE, P.L.C., P.O. BOX 828, BLOOMFIELD HILLS, MI, 48303, US

(21) Appl. No.: 10/068,169

(22) Filed: Feb. 5, 2002

(51) Int. Cl. G06F 17/60

(52) U.S. Cl. 705/1

(57) ABSTRACT

A media delivery system offers a low-cost consumer alternative to traditional media delivery offerings and provides fully selectable and controllable media to consumers through a personal media device. Media suppliers in the system provide and manage the content in a data center through a supplier management system. The system profiles consumers and their behaviors as they interact with the system, and the personal media device is operable to exchange profiling data with a data warehouse in the data center. Information derived from the data warehouse is, in turn, utilized by the media suppliers to create revenue streams, increase internal knowledge, and optimize internal processes.

### FIELD OF THE INVENTION

The present invention relates in general to a media delivery system for distribution of multimedia products to a consumer, and, more specifically, to a total choice and total control media system that allows a consumer to choose and control the playback of media such as music or video while providing suppliers of the media with marketing information and business opportunities.

### BACKGROUND AND SUMMARY OF THE INVENTION

The present invention relates generally to a media delivery system that provides a consumer with total choice and total control over the selection and playback of media on a personal media device such as a computer.

Traditionally, various forms of media can be selectively played back by a consumer. The various forms of media contemplated by the present application include music, television shows, movies, audio books and any other type of product that a consumer listens to, sees, or can otherwise interface with at the human level. Traditional forms of disseminating media to consumers include broadcasting, such as radio and television, and physical forms, such as tapes, records, videocassettes, compact discs (CDs), and digital video discs (DVDs)..

The problem with broadcasting is that the consumer has limited control over what media is played and when it is played. This is because the broadcaster has a limited selection of media available and a limited time in which to present that media to consumers. Selection and playback are accomplished at the discretion of the broadcaster. This prevents listeners from selecting the media they want at the time they prefer.

The problem with physical media forms, such as CDs and DVDs, is that the consumer has limited financial and spatial resources to purchase and store them. In addition, the consumer is limited to the selection of the media currently in possession.

Another problem experienced by traditional media delivery systems is that they do not account for individual consumer preferences when selecting content. Preferably, a media system would provide a method for automatically selecting content the consumer would find interesting. This would provide consumers with a series of selections tailored to their individual tastes, a feature not presently offered by traditional media delivery systems.

A preferred media delivery system would allow media to be distributed to “permanent” devices, such as home stereo and television systems, as well as “mobile” devices, such as a portable radio or portable television. It would allow consumers to make selections from all of the available media at a place and time convenient to the consumer.

A preferred media delivery system would allow media suppliers such as record labels, film producers, television producers, and audio book producers, to self-manage the media available to consumers. It would allow media suppliers to control the availability and use of their media thus protecting their copyrights.

The preferred media delivery system would record data about the consumers and about their use of the media. This would provide media suppliers and their partners with a method for obtaining and using marketing information. For example, by using demographic data, consumers could be targeted for advertising or other products. Another example would be to use data collected about consumer behaviors with respect to media selection in order to optimize a media supplier's planning or distribution operations.

In view of the foregoing problems and objects to be accomplished, an improved media delivery system is provided. According to one aspect of the present invention, a total choice and total consumer controlled media system includes a data center that contains databases for cataloging media and other products and for storing subscriber and usage data. The system also contains a data warehouse that collects data from all other databases for use in ad hoc queries. The system further includes a management system to allow suppliers to maintain their own product databases. A consumer media device is further provided and is operable to exchange data with the data center through a personal media services server. Consumers provide behavior and preferential feedback to the tracking and subscriber databases which, in turn, update the data warehouse. Also provided is a reporting system that produces information for suppliers in order to support operational decisions.

Another aspect of the present invention provides a media delivery system that includes a management server system. The management server system includes a media, advertising, channel, and catalog management server. Each of the management servers are operable such that the data is maintained by a supplier such as a record label or a movie company.

The media delivery system further includes a database for each management server whereby the database houses information from each supplier. A personal media services server is also provided that is in communication with each database. A data warehouse is also provided that is in communication with a personal media services server. A tracking database is connected to the personal media services server. An interface is provided that extends between the personal media services server and a personal media device for transmitting media to a consumer. The personal media device has an output means for a consumer to observe the media that is being transmitted within the system.

Another object of the present invention is to provide a method of delivering media to consumers on a system that includes the steps of providing consumers with total choice and total control through a personal media device. The method further includes the step of profiling consumers such that their demographics and behaviors are stored in a data warehouse. The method further includes the step of providing media suppliers with a targeting and reporting system that allows them to deliver marketing or other messages to a targeted group of consumers and to develop reports around a targeted group of consumers. The method further includes the step of generating revenue for the media supplier by allowing marketing partners, such as advertisers or merchants, to provide targeted consumers with products or services that match a particular profile. The products or services can be offered directly through the personal media device and can be selected by an interested consumer.

Another object of the present invention is to provide a method of doing business that includes four strategic pillars of operation. The first pillar being known as C³ where a consumer is given a personalized system with total choice and control over the selection and playback of media at low cost. The second pillar is known as the data center whereby a set of consumer profiling tools produce and store a wealth of information about a consumer's demographics, consumption behaviors, and other parameters. The third pillar is known as the information portal whereby a set of reporting tools are designated to provide fast, accurate information based on the data center and whereby additional information requests can be sent to consumers. The fourth pillar, known as the profit opportunity pillar, is a value proposition for media suppliers that provide profit opportunities via the information portal.

These and other aspects, objects, and advantages of the present invention will be further understood by examining the preferred embodiments of the present invention illustrated in the drawings and by studying the detailed description and the claims found below.

### BRIEF DESCRIPTION OF THE DRAWINGS

FIG. 1 is a flow diagram of the interactive total choice and control media delivery system.

FIG. 2 is a flow diagram of a four point method of doing business whereby consumers are attracted by total choice and total control over media selection and playback; data about the consumers and their activities are collected; the data are used to provide information useful to suppliers; and the information provided to suppliers creates opportunities to improve profits.

FIG. 3 is a schematic diagram illustrating in greater detail the delivery system depicted in FIG. 1 and specifically showing the preferred architecture for implementing the four point method of doing business that is described in FIG. 2.

FIG. 4 is a flow diagram of the steps the system goes through when the consumer logs on to the personal media device.

FIG. 5 is a flow diagram of the steps a consumer goes through with a personal media device in order to play a program.

FIG. 6 is a flow diagram of a method of utilizing voice activation to interface with a personal media device.

FIG. 7 is a flow diagram of a dynamic programming module that is utilized in the present invention showing automatic assembly of a collection of media programs based on predetermined rules.

FIG. 8 is an example of the preferred embodiment of the present invention showing a personal media device screen in which an existing subscriber authenticates to the system.

FIG. 9 is an example of the preferred embodiment of the present invention showing a personal media device screen by which a new subscriber creates a profile in order to use the system.

FIG. 10 is an example of the preferred embodiment of the present invention showing a personal media device screen in which a subscriber can access detailed information about the selected artist, song, album, or obtain lists of similar artists, songs, or albums.

FIG. 11 is an example of the preferred embodiment of the present invention showing a personal media device screen in which a subscriber can browse music categorically or search for music using metadata.

FIG. 12 is an example of the preferred embodiment of the present invention showing a personal media device screen in which a subscriber can create and manage a list of favorite artists, songs, albums, or stations.

FIG. 13 is an example of the preferred embodiment of the present invention showing a personal media device screen in which a subscriber can browse or search for merchandise related to the currently selected song and can purchase the merchandise directly through the personal media device.

FIG. 14 is an example of the preferred embodiment of the present invention showing a personal media device screen in which a subscriber can browse personalized stations categorically, search for stations using metadata, or get a list of suggested stations.

FIG. 15 is an example of the preferred embodiment of the present invention showing a personal media device screen in which a subscriber, moving down from the screen shown in FIG. 14, can view detailed station information and perform other actions.

### DETAILED DESCRIPTION OF THE PREFERRED EMBODIMENTS

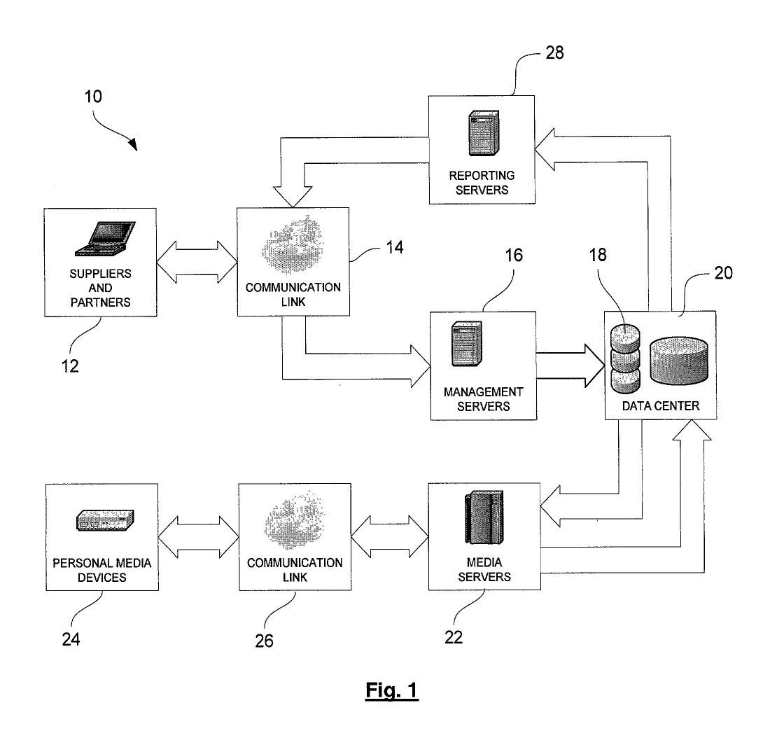

With reference to FIG. 1, a system overview for a media delivery system allowing consumers total choice and total control 10 is illustrated. Media delivery system 10 includes input by suppliers 12 through a communication link 14. Products and services are offered through the communication link 14 by the suppliers 12 which are in turn controlled by management servers 16. The management servers 16 include individual databases 18 that store the information from the suppliers that may be of interest to consumers. The databases 18 are in turn linked to and are accessible to a data warehouse 20 that operates as a collection position for the information stored in the individual databases 18. A media server 22 is in communication with the data warehouse and supplies information to and from personal media devices 24 via a communication link 26. Consumer profiling information, such as age, location, media play, interests, etc., is generated from the personal media device 24 and is communicated back through the communication link to the media server 22. The information in turn is then directed through the data warehouse 20 to a reporting server 28. The reporting server 28 functions to manipulate the data in the date warehouse so as to provide consumer marketing information back through communication link 14 to the suppliers 12. This valuable consumer marketing information can be in the form of market research, advertising reports, or the like, and in any format that is preferred by the suppliers.

The communication links 14 and 26 are preferably secured networks using Internet protocols and can be either wired or wireless.

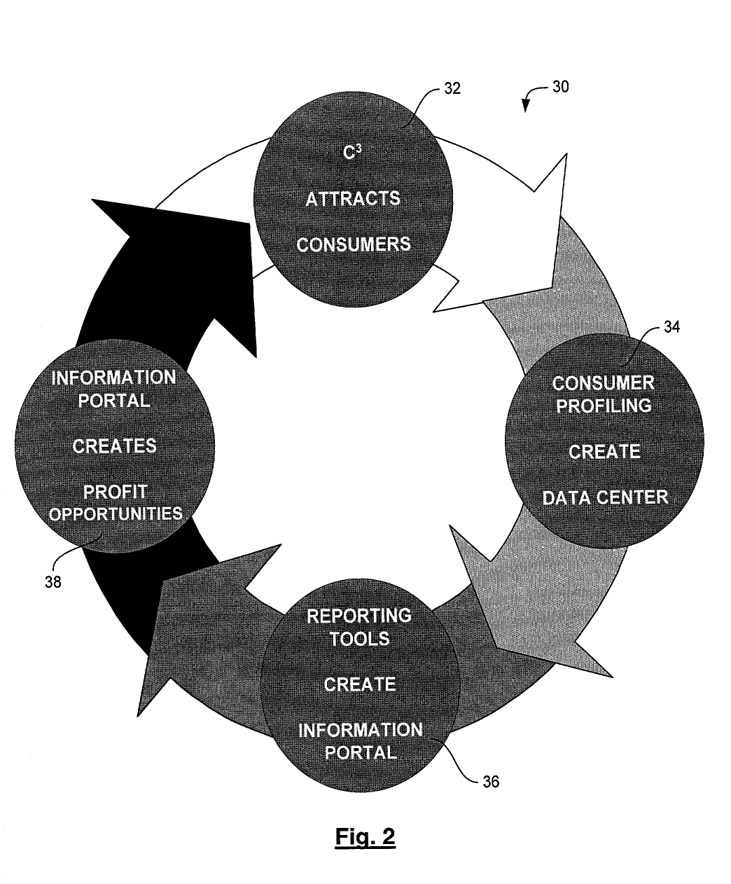

With reference to FIG. 2, a four pillar business model or method of doing business 30 is illustrated. The model 30 includes a C³ pillar 32, a data center pillar 34, an information portal 36 and a profit opportunity pillar 38. These four pillars interact together to provide total choice and control by the consumer of multimedia products as well as generating valuable information for suppliers of the media and an opportunity for the suppliers to generate a profit. It will be appreciated that the business model 30 can be fee-based, can be advertising-driven, or a combination of each..

The C³ pillar is the portion of the business model that provides total choice, total control and low or no cost to the consumer who is utilizing the system. The choice of media selection allows a consumer to have prompt access to media that the consumer wants, when the consumer wants it, and wherever the consumer happens to be. The control feature allows the consumer to pause, rewind, fast forward, skip to the next program, skip back to the program, and keep a list of favorites for instant recall. The cost parameter in this pillar allows the business model to attract the largest possible consumer base. It will be appreciated that the system can be operated in different modes such as a broadcast mode or an on-demand mode. The four pillars can be used in either mode.

The data center pillar 34 is provided by the community that is created by those utilizing the C³ pillar 32 which allows for anonymous consumer profiling to create information on the system's listeners. The consumer profiles that are generated by the data center 34 allow copyright holders, record companies, movies companies, and other media suppliers to better understand their market. It further allows market research companies to receive access to fast, accurate market information based upon real events rather than statistical sampling. Further, the data center 34 provides direct marketing, advertising and merchandising companies with raw information that allows a series of value-added products to be built.

The information portal pillar 36 leverages the raw information that is contained within the data center 34 to create the value-added products, such as reports. These reports are utilized by direct marketing and advertising firms who need to direct information to targeted consumers. Record companies who desire to quickly and accurately obtain feedback on consumer's tastes on new artists or music are intended to benefit from this information portal 36. Moreover, merchants who desire to sell products or services directly to consumers can be targeted by the information portal 36. And finally, market research firms who desire to study consumer behavior or demographics in a certain media market, such as the music market, would benefit from utilizing the information portal 36.

The profit opportunity pillar 38 provides incentive for copyright holders and media providers to provide the total choice control and low cost media to consumers. The incentive for copyright holders and media providers includes greater operational efficiency by leveraging real-time market information. For music labels, the incentive provides for reduced risk when introducing new artists or music by leveraging automated, low-cost testing and research against a large, diverse community. The content available to consumers is contained within the system and thus there is a reduced risk of loss from piracy. Marketing costs can be reduced through targeted messages and promotions. There is a greater marketing and sales leverage of existing consumer base through continuous relationships long after products are sold. These items are referred to as the bottom line improvements that are offered by the current system.

The profit opportunity pillar 38 further provides top line improvements such as continuous revenues from direct marketing and advertising firms who seek to deliver messages to new listeners. New revenue-producing products for market research companies can be offered for those who can benefit from data stored in the data center 34. Continuous revenues from subscription fees can be levied for premium services if the supplier chooses a subscriber-based fee system. Both the bottom line and top line features provide an incentive for copyright holders and music service providers to provide the C³ pillar 32. Thus, the business circle is completed as depicted in FIG. 2.

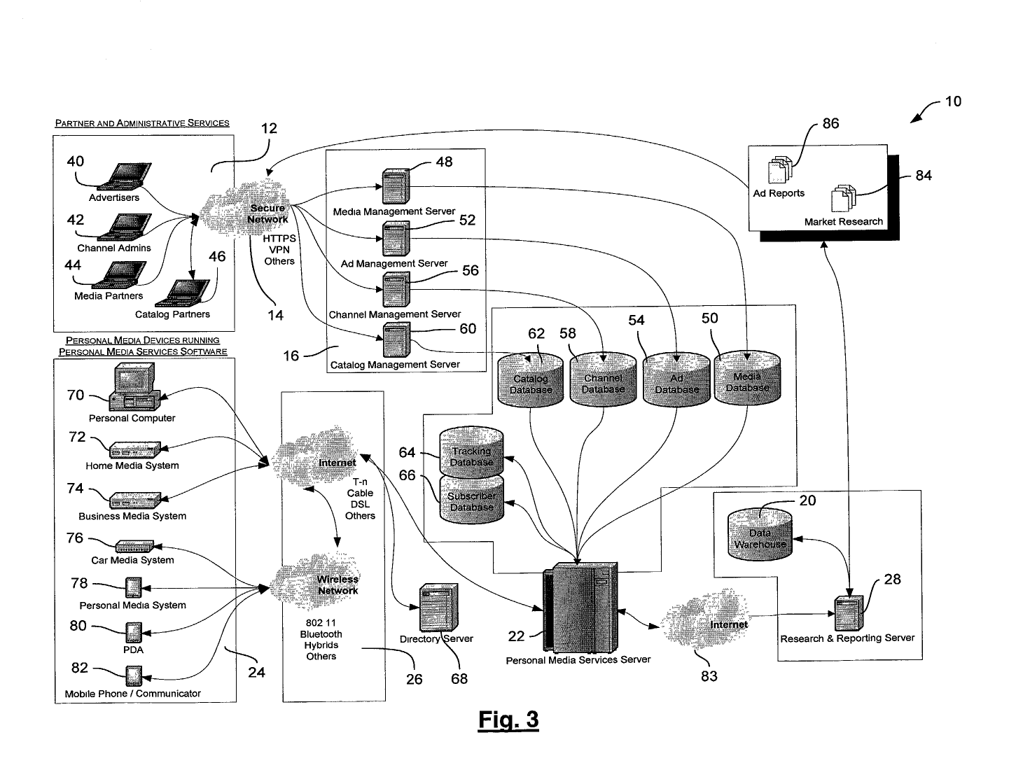

With reference to FIG. 3, the media delivery system 10 and its architecture is illustrated in greater detail than that which was previously disclosed in the schematic diagram of FIG. 1. The system 10 includes suppliers 12 of products and services to consumers. Suppliers 12 include advertisers 40, channel administrators 42, media partners 44, such as record labels, film companies, music publishers, etc. and catalog partners 46, such as suppliers of goods through catalog sales. Together these groups channel their products and services through a secured network via a communication link 14 to their own individual management servers 16. For example, media partners 44 may manage their own media management server 48 that contains its own media database content 50. The media database 50 would include music that is controlled by record labels. It will be appreciated that multiple media management servers could be utilized thus providing each supplier with its own media database for it to control and disseminate the contents thereof to consumers. Other examples of the content within a media database could include films, videos, etc., from film companies, video publishers, video distributors, artists, producers, etc.

The advertisers 40 utilize their own advertisement management server 52 that in turn manages their own advertising database 54. The advertising database would include advertisements, targeting parameters, display parameters, and other information that could be used to target and disseminate advertising messages to consumers through their personal media device 24.

The channel administrators utilize their own channel management server 56 that in turn manages their own channel database 58. The channel database would include collections of media and metadata describing those collections. This data is used to make channels—also known as “stations” in radio parlance—available to consumers. Likewise, the catalog partners 46 utilize their own catalog management servers 60 that in turn manage their own catalog database 62. The catalog database 62 could include a listing of readily available products a consumer could purchase and such products can be directly targeted to interested consumers via their personal media device 24.

The personal media services server 22 is a server object that contains its own tracking database 64 that maintain usage and behavioral data consumers who are utilizing the system including behavioral patterns, and characteristics that are attributable to an individual's usage of the system. A subscriber database 66 maintains information on each individual user, including demographics and other marketing data. It will be appreciated that the present media delivery system 10 can be a fee-based or an advertising-driven system. If a fee-based system is employed, then the subscriber database 66 can be utilized to maintain fee payments and other account information pertaining to a particular consumer.

The communication link 26 provides the interface between the personal media services server 22 and the personal media devices 24. The communication link 26 can be an interface that is hard-wired through high-speed data networks employing Internet protocols. By contrast, the communication link 26 can be effectuated through either wired or wireless networks. It is important that the communication link 26 provide 2-way communication of data. A directory server 68 could be utilized to interface with the communication link 26 to provide users with a level of isolation from physical or logical changes to system's infrastructure.

The personal media devices 24 preferably include personal media services software that is compatible with the communication link 26. Various personal media devices are contemplated including a personal computer 70, home-based media system 72, business-based media system 74, vehicle media system 76, personal portable media system 78 or some other form of personal digital assistant (PDA) 80 or mobile phone/communication device 82. Each of these media devices include playback components allowing the human to interface with the personal media services server 22. They further each include an output screen, at least one speaker, and appropriate input control mechanisms, allowing the consumer to interact with the personal media device so as to provide input which in turn allows data to be transmitted to, and received from, the personal media services server 22. It will be appreciated that voice controlled personal media devices 24 can be employed to allow non-visual, non-tactile control of the device. When the media device is specifically for audio-only media, the output screen may be removed, leaving at least one audio speaker..

The media delivery system 10 further includes architecture for allowing suppliers 12 of the system to produce information that will assist them in making marketing, planning, or other operational decisions. This is accomplished by providing a communication link 83 between the personal media services server 22 and the reporting servers 28. The reporting server 28 utilizes the data warehouse 20 and the other databases in order to provide both fixed and ad hoc queries for information such as market research 84 and advertising reports 86 back to the suppliers 12 via the communication link 14. It will be appreciated that the market research 84 and advertising reports 86 can be generated automatically as data from the consumers is input through the media services server 22. This provides suppliers 12 with continuous feedback of pertinent information that allows the suppliers 12 to target consumers with products or messages.

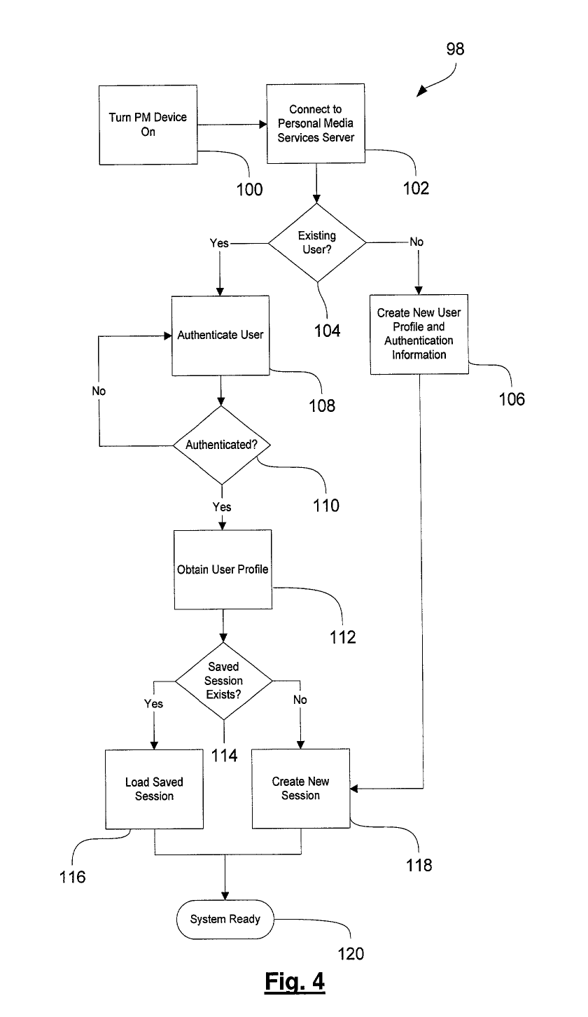

The method of operating the media delivery system 10 will now be presented. FIG. 4 depicts a flow diagram of a log-in 98 routine that can be employed by a consumer. Initially, a personal media device 24 is turned on via a switch or by voice command 100. This causes the personal media software to automatically launch. Next, the personal media device 24 is connected 102 to the personal media services server (PMSS) 22 by first retrieving a list of known directory servers 68 from its internal store, and then sequentially connecting to each directory server 68 and requesting an IP address and port number for an appropriate PMSS 22. If no directory server 68 can be found, or no appropriate PMSS 22 is available, the device displays a “service unavailable” message. The personal media device 24 will continue to search for service until turned off. It will be appreciated that a directory server 68 does not need to be utilized. Instead, the concept may be implemented by directly having a list of PMSS 22 which are then contacted directly in sequence until one responds. If a directory server 68 is utilized, this will isolate devices from changes in the physical and logical infrastructure.

Next the system 10 prompts the consumer 104 in order to ascertain whether they are an existing user. This is accomplished by the personal media device 24 displaying or vocalizing a list of known user IDs. Alternatively, if the user is not an existing user, then they may elect to create a new user profile 106. When this occurs, the user is presented with an interface, either visually or by voice activation, and is prompted to enter a desired user ID and possibly other authentication information. A consumer profile is then created which consists of demographic, behavioral, or other characteristic information such as zip code, date of birth, number of children, types of pets, etc. Once the requested information has been entered, it is stored in the subscriber database 66. It will be appreciated that certain authentication methods, such as the use of fingerprints or retina scans, would allow the user to automatically enter both user ID and authentication signature simultaneously.

Referring back to the option where there is an existing user, the next step is to authenticate the user 108. This can be accomplished through password, voice imprint, bio-data such as iris identification, smart card or proximity card. If the user is authenticated 110, then she is passed on to where the PMSS 22 retrieves the user's profile 112 and any saved session ID from the subscriber database 66 using the user ID as a key. If there were any saved sessions 114, then it is restored by a load saved session request 116, allowing recovery of a previously saved session through the personal media device 24 and allowing it to return to the place left off prior to being turned off. If no load save session 116 was saved, then the user can create a new session 118. At this point, the system is now ready 120 for utilization by a consumer. It will be appreciated that users may select an option exempting them from entering authentication information in order to gain entry to the system. This will provide a faster and more convenient process for using the system at the expense of user data security.

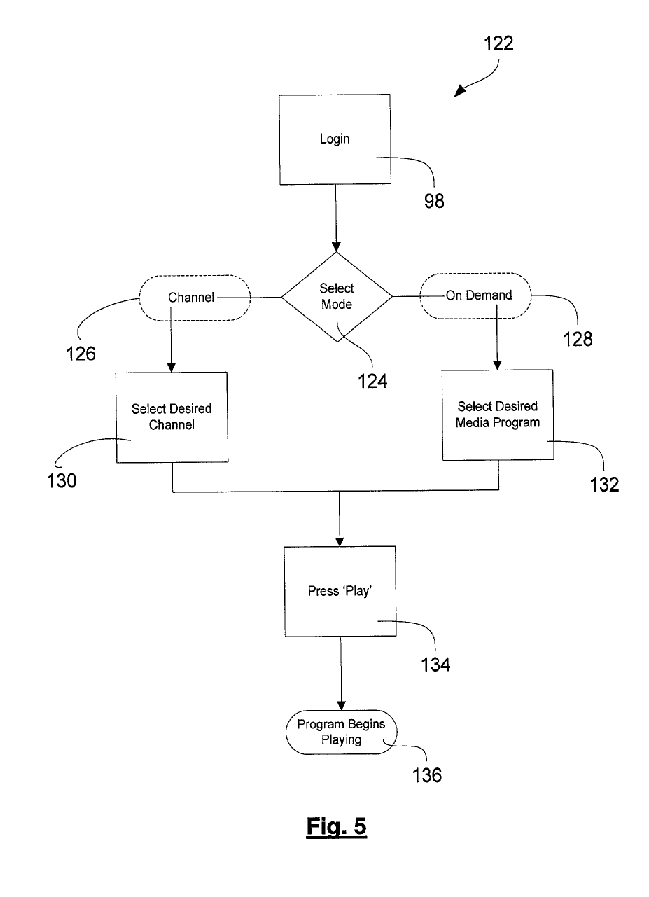

With reference to FIG. 5, a consumer usage diagram 122 is depicted. This diagram depicts the steps a consumer would go through after logging in. (See log-in function 98 that was discussed above). Once the consumer has properly logged-in 98, the user can select the mode of operation 124 which allows the user to utilize the system 10 in two primary ways. First, channels 126 allow a user to emulate radio or television or other broadcast mediums in which a series of programming is created on behalf of the consumer and then played in a sequence. Alternatively, the on-demand mode 128 emulates CD players or DVD players or any other medium in which the user selects the specified programs and potentially the order of the programs.

If a consumer chooses the channel 126 mode, a selected desired channel 130 can be chosen from a menu on a screen, by saying the name or unique identifier of the channel into a voice recognition system, or any other direct selection mechanism. Channels 126 can be located by utilizing a criteria-based searching service in which the user identifies desirable properties and the service narrows down the list of matching channels, from which the user may select one or more thereof. The consumers have the option of selecting multiple channels 126 thereby creating a super channel that acts as a single channel with combined resources of all encompassed channels. If the consumer selects the on-demand 128 mode of operation, then the user can select a desired media program 132. This option allows a consumer to select a specific program or set of programs by selecting them from a menu on a screen, by saying the names of each program, or any other direct selection mechanism. Programs may be found by utilizing a criteria-based searching service that allows the consumer to identify desirable properties and the service narrows down the list of matching programs, from which the user may select one or more thereof.

The consumer can then hit the play button 134 or say “play” into a voice recognition module in order to begin the selected program series. This allows the selected audio or video to be diverted to the proper hardware resources in accordance with the program. When this occurs, the program begins to play 136.

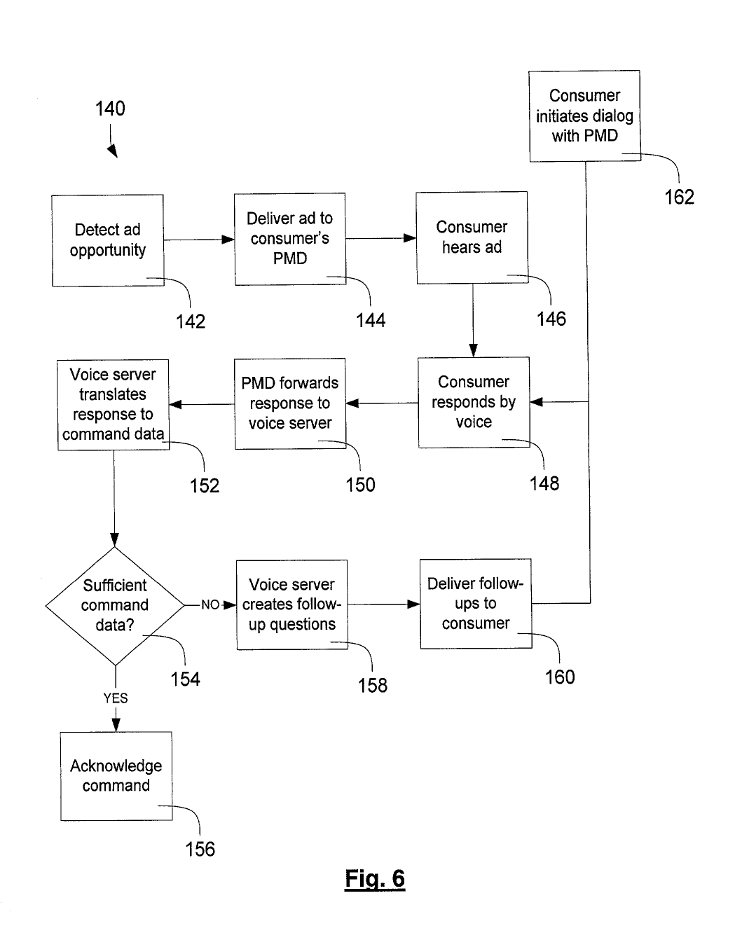

With reference to FIG. 6, a schematic diagram of an optional voice activated interactive advertising system 140 is disclosed. The system 140 is initiated after the user has properly logged into the system 10. The next step for the voice activated system 140 is to detect advertising opportunity 142. This is accomplished by an advertising server 52 using profile-matching to target consumers in order to detect an advertising opportunity with the consumer. An opportunity may be a manually initiated command request in which another user sends an audio or video message to the consumer. Advertisers are targeted by applying rules that select consumers with specific sets of parameters that match those rules.

The next step allows an advertisement to be delivered 144 to the consumer's personal media device where the advertisement can be heard 146. The advertisement can be broadcast via video screen or by speakers and the appropriate medium can be determined by examining the metadata delivered with the advertisement. It will be appreciated that the advertisement can be automatically converted from audio to text through a speech-to-text module if no speakers are available. Next, the consumer responds by voice 148 in order to interact with the advertisement through the personal media device 24. The personal media device 24 then forwards the response 150 to a voice server where the vocal response is converted into data packets and sent to a voice server across the network for processing.

Next, the voice server translates the response to a data command 152. Once this occurs, the system determines if there is sufficient command data 154 in order to process the request. If there is sufficient command data 154, then the command 154 is acknowledged 156 to the consumer. If the command data is insufficient to process the request, then the voice server creates follow-up questions 158. This is accomplished by the server looking up follow-up questions in a workflow description. For example, if a consumer is buying tickets to a concert, the follow-up question might be “How many tickets do you need?” and the consumer might respond “I need two tickets.” Also, the follow-up questions could ask “Which arena would you like tickets for?” or “Would you like to pay by credit card? And, if so, what is your credit card number?” The system continues to follow-up with the consumer 160 until sufficient command data has been received in order to process the request so that it can be acknowledged 156. At which time, the system may acknowledge the command by saying “Thank you, your order number is 12345. Your tickets are being delivered to your home.”

An alternative form of the voice activated system 140 includes a consumer initiating dialog 162 initially with the personal media device in order to inquire about something or to control the device by voice. An example of inquiries through the personal media device 24 could include, “I'd like to check on the status of my order number 12345.” Further, controls such as fast forwarding, selecting artists, selecting songs, etc., could be initiated through the consumer initiating dialog feature 162.

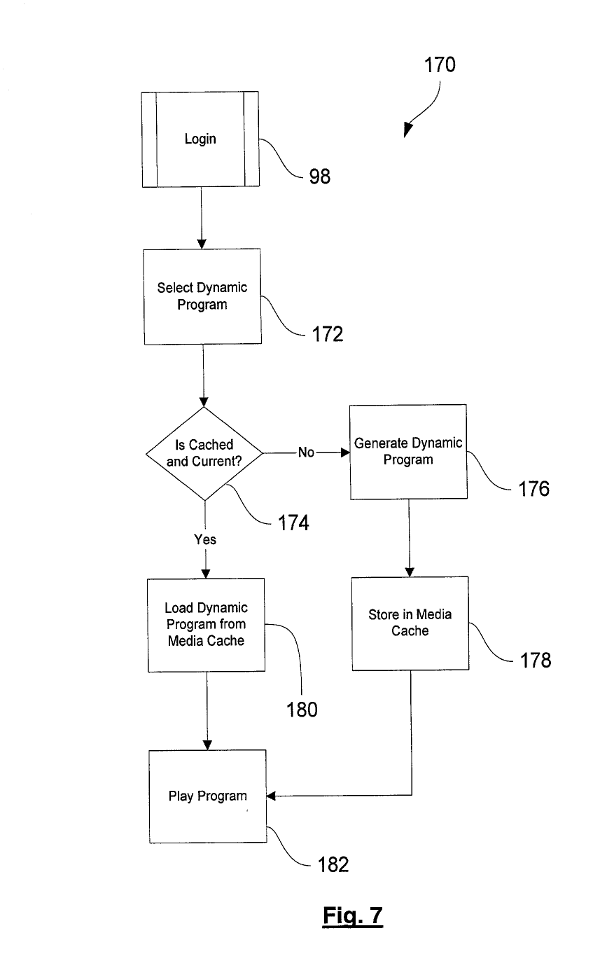

With reference to FIG. 7, a dynamic programming module 170 is illustrated which is the feature in the system 10 that provides for automated assembly of a collection of media programs based on pre-determined rules within the system. To initiate the dynamic programming module 170, the consumer must log-in 98. Next, the consumer must select a dynamic program 172 from a menu on a screen of personal media device 124 by either saying the name or other unique identifier of the program into a voice recognition system, or any other direct selection mechanism. Programs may be found utilizing a criteria-based searching service in which the user identifies desirable properties and the service narrows down the list of matching programs, from which the user may select one or more thereof. It will be appreciated that the user may select multiple programs thereby creating a “super program” such as American Top 40, England's Top 40, Japan's Top 40, which together could become one program. The “super program” acts as a single program with the combined resources of all encompassed programs.

Once the program is selected 172, then the system checks 174 the media cache to see if the dynamic program has been cached and is up to date. A cached dynamic program contains logic specific to the program that allows it to say whether or not it is up to date. It will be appreciated that the media cache can be stored on the personal media device 24 or elsewhere in the system 10.

If the media cache is not up to date, then the system must refresh the list of media specified by the dynamic program. A dynamic program that produced the top 10 songs in the United States, for example, would be refreshed by accessing the tracking database 64 and examining the United States popularity rankings of specific music.

Once the dynamic program 176 is refreshed, the media specified by the dynamic program is stored in the media cache 178. If, however, the media cache is already updated, then the system loads the dynamic program from media cache 180 instead of refreshing it. This feature provides for extra scalability and performance of the system 10. Once the program is loaded, it can be played 182. Alternatively, the consumer can execute another operation such as obtaining metadata information about the dynamic program.

FIGS. 8 through 15 depict human interface screens that a user would see on her personal media device 24 during operation of the system 10. With specific reference to FIG. 8, this is the first screen a consumer sees when she is logging in to the system 10 using her personal medial device 24. The welcome screen 190 includes typical pause, play, rewind, fast forward, volume, skip forward, skip backward, and other control buttons 192. This screen further includes a login feature 194 which provides the consumer with access to the system 10. The screen 190 further includes a video output section 196 that allows the consumer to visualize media, advertisements, or other product information from the suppliers 12, or tutorials and other help material on how to use the device and its software.

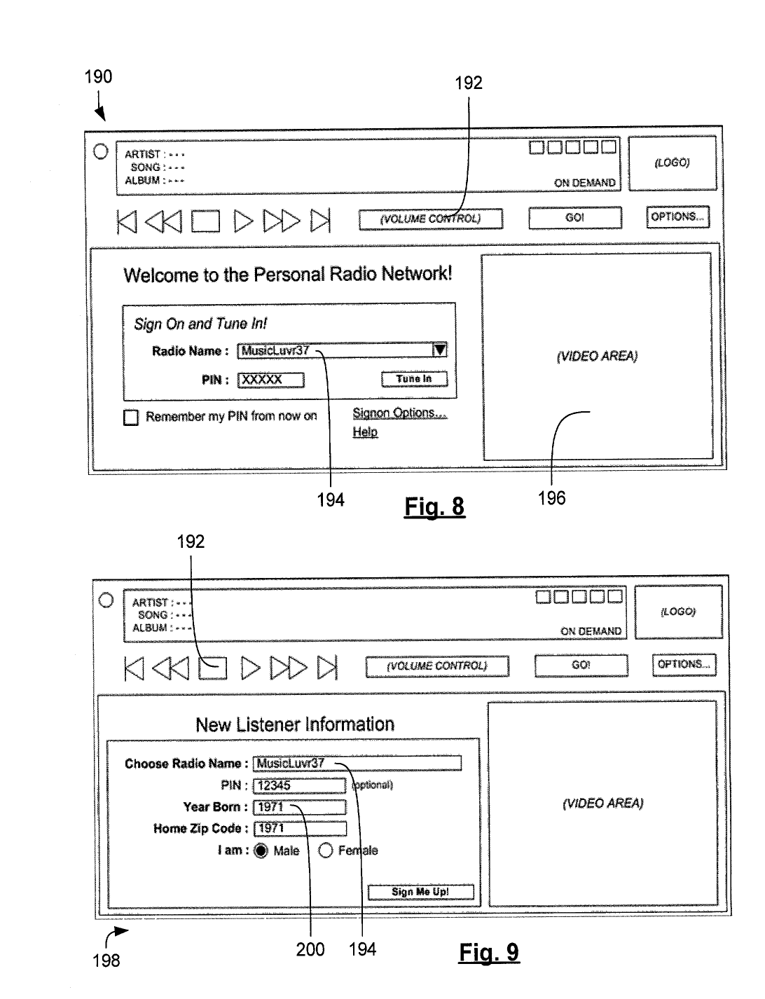

FIG. 9 is a new listener screen 198 that is used for new users of the system 10. The consumer is allowed to select her log-in name 194 as well as optionally provide a pin number. Other predetermined start up information 200 is input into the system which is used to initiate and create the consumer's personal profile that is stored in the subscriber database 66. It will be appreciated that the system 10 can periodically prompt the consumer to provide additional information so as to provide on-going market research 84 for suppliers 12.

FIG. 10 illustrates a human interface information screen 202 that a consumer sees once she is in the system. Various features are now available for the consumer to utilize in order to listen to music. It will be appreciated that the screens depicted in FIGS. 10-15 are for use with music listeners. It is contemplated by this invention to provide similar screens for viewers of movies or those interested in interacting with other forms of media.

With continued reference to FIG. 10, the various features available for the consumer is an information feature 204, a find music feature 206, a news feature 208, an events feature 210, a merchandise feature 212, a favorites feature 214, a stations feature 216 and a message board feature 218.

With respect to the information feature 204, the consumer is offered to select detailed information 204 about a particular artist, a song, an album or to obtain a list of similar music. In FIG. 10, the screen shows the consumer has chosen the artist selection 220 to get information about Rod Stewart. This invention allows the consumer to obtain detailed information about any other artist that is within the system's databases. Such information can include the artist's latest albums, reviews, biographies, etc.

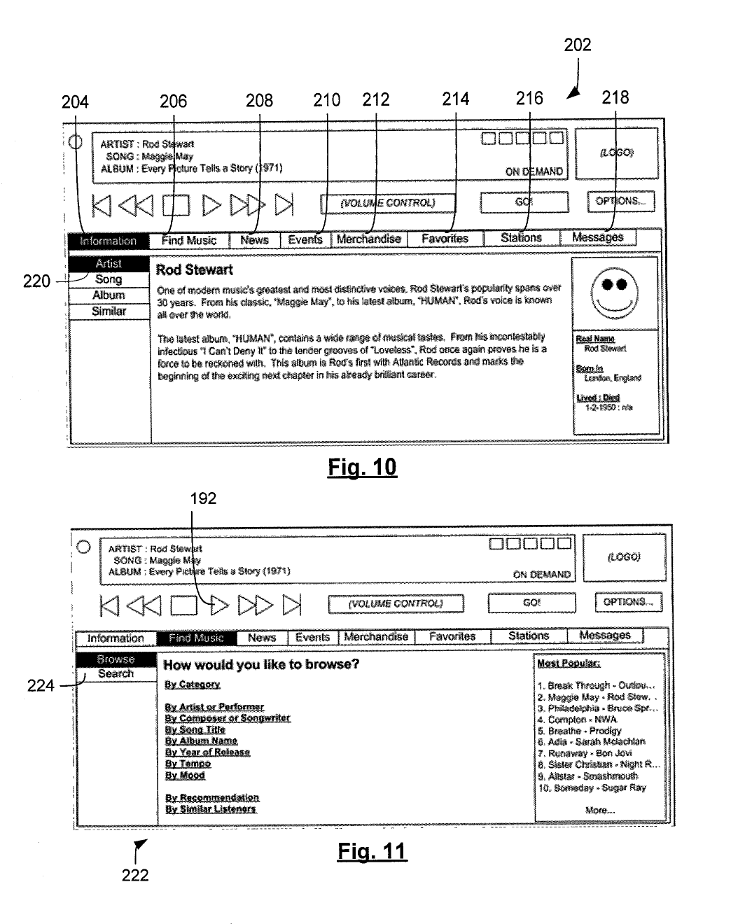

FIG. 11 depicts a find music screen 222 that a consumer sees when she selects the find music feature 206. The consumer is prompted with the option of browsing or searching 224, which can be accomplished by category, artist, composer, song title, etc. The user navigates the find music screen 222 by continually narrowing search criteria and reviewing the resulting list of media. This feature allows the consumer to have total choice over the music she would like to listen to. In combination with the playback controls 192, the user also gains total control over when and how she is going to listen to the music.

FIG. 12 depicts the favorites screen 226 that occurs when the consumer selects the favorites button 214. This feature is similar to the favorites option on Microsoft's Internet Explorer window and allows the consumer to create favorite categories 228 by songs, artists, songwriter, albums, stations, etc. This favorites information is stored in the subscriber database 66 and becomes part of the consumer's personal profile of preferred media to listen to. By building this list of favorites, the system 10 is capable of locating other media that the consumer may be interested in listening to. This allows suppliers 12 in the system to develop a pattern of preferences by the consumer so as to allow the supplier to provide new media to the consumer that the consumer potentially would be interested in reviewing. System 10 uses the tracking database selections and frequency of selections when in the stations mode in order to provide personalized media content for each individual consumer. If the song category 228 is selected, the consumer is prompted with the song title, the artist's name, the songwriter's name, the album in which the song appeared and the year that the song was released. It will be appreciated that other information can be provided by the suppliers 12 and that modifications of the favorites screen 226, and the other screens, could be contemplated. It will also be appreciated that the system can cache media selected as a favorite in order to provide additional performance and scalability.

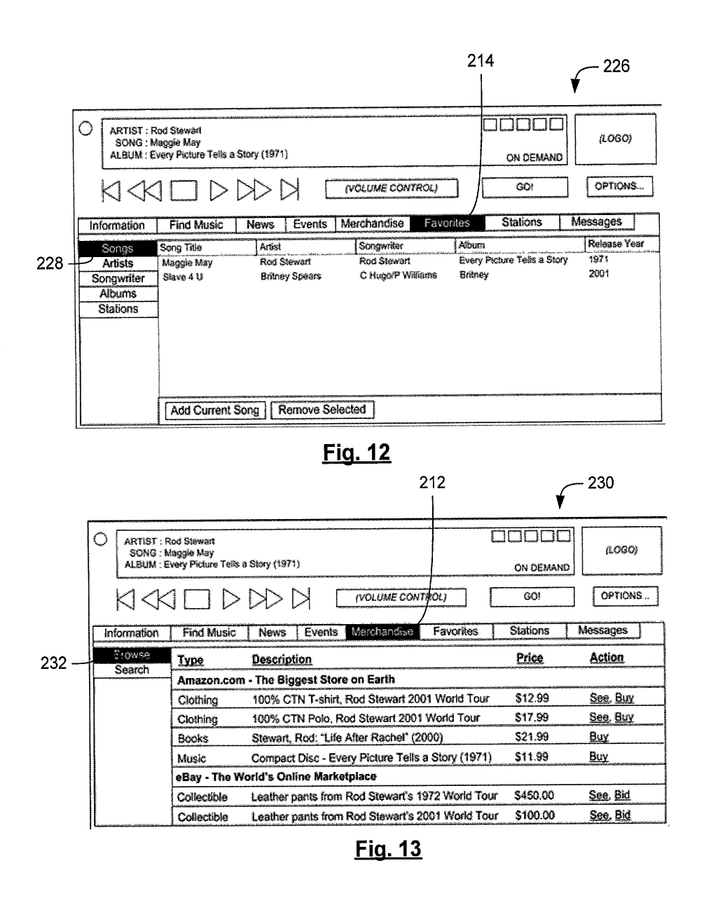

With reference to FIG. 13, a merchandising screen 230 is depicted and this occurs when the consumer selects the merchandise button 212. When the merchandise button 212 is selected, the consumer is provided with a browse or search selection 232. When the browse selection 232 is chosen, the consumer sees what is depicted in FIG. 13 thus allowing her to select merchandise from catalog partners 46 such as Amazon.com, eBay, Borders, etc. and make on-line purchases of products that pertain to a particular artist. Once the consumer makes the selection, she can directly purchase the product, have it automatically billed to her credit card, and have the product automatically sent to a predetermined address. It will be appreciated that the consumer may also elect to purchase the product in other ways, such as cash-on-delivery (COD), direct billing, or any other method of payment, and that the system could be designed to allow her to determine billing and shipping information at the time of purchase rather than having them predetermined.

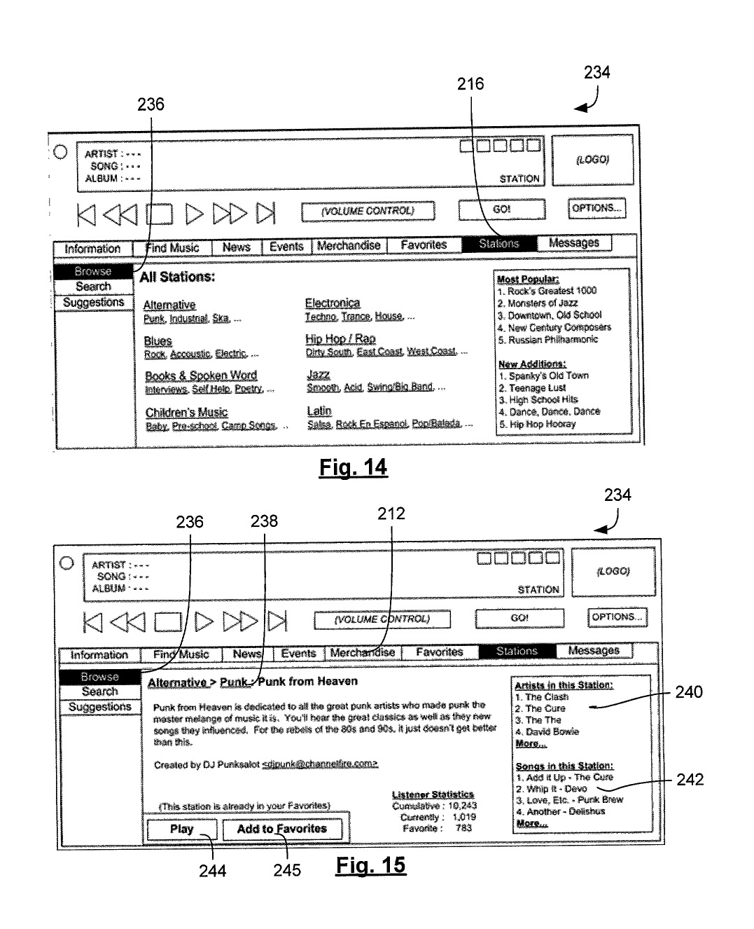

With reference to FIG. 14, this is the stations screen 234 a consumer sees when she selects the stations button 216. The consumer is provided with a browse, search or suggestions option 236 once the stations screen 234 comes up. In the screen that is shown in FIG. 14, the browse option 236 has been chosen thus allowing the consumer to preview the various forms of music that are provided in the system 10. The consumer can select by music type, such as alternative, blues, hip hop, etc. and, within each of these substations, find music to which she is interested in listening.

FIG. 15 depicts a subset of the station screen 234 that depicts more detailed information on the selected station. Here, the user has chosen the alternative punk station 238. This screen shows information about the station that was entered by the channel administrator 42. From this screen the user can see a partial list of artists 240 that are represented in this station and can select the partial list to view a complete list. The user can also see a partial list of songs that are represented in this station 242 and can select the partial list to view a complete list. The user can press the play button 244 to begin listening to the chosen alternative punk station 238 and even add it to her favorites list 245. Other music can be selected utilizing the same steps or, the consumer can log off whereby the personal media device 24 disconnects from the system 10.

For the following specification taken in conjunction with the accompanying drawings, independent claims, other objects, features and advantages of the present invention will become apparent to those skilled in the art.

What is claimed is:

1. A method of delivering media to consumers comprising the steps of:
(a) providing media consumers with total choice of selection and total control over playback through a personal media device;
(b) profiling consumers and automatically storing the profiled data in a data warehouse;
(c) providing media suppliers with a targeting system that directs messages or products to, and provides reporting on, a particular consumer group; and
(d) providing media suppliers with revenue streams and operational efficiency opportunities through the targeting system.

2. The method of delivering media as claimed in claim 1, whereby the consumer pays no fee to use the system.

3. The method of delivering media to consumers as claimed in claim 1, further comprising the step of charging consumers a fee to use the system.

4. The method of delivering media to consumers as claimed in claim 1, wherein the step of providing total choice and control through a personal media device includes automatically providing a consumer with media that is of possible interest to the consumer and expanding the consumer's profile of preferred media.

5. A method as claimed in claim 1, wherein the personal media device is operable to function when disconnected from the system and to continue in a limited manner.

6. The method of delivering media to consumers as claimed in claim 1, wherein the step of profiling consumers includes storing data in response to predetermined consumer interactions with the system.

7. The method of delivering media to consumers as claimed in claim 1, further comprising the step of processing the data stored in the data warehouse to generate reports.

8. The method of delivering media to consumers as claimed in claim 1, wherein media suppliers interface with the data warehouse and generate reports about consumer preferences for media.

9. The method claimed in claim 1, further comprising the step of the media supplier conducting market testing on a group of consumers through a personal media device.

10. The method of delivering media to consumers as claimed in claim 1, further comprising the step of the media supplier targeting products the consumer may be interested in purchasing and automatically providing information about the products to the consumer directly through the personal media device.

11. The method as claimed in claim 1, further comprising the step of providing the consumer with a means for purchasing the products directly through the personal media device.

12. The method of delivering media to consumers as claimed in claim 1, wherein the step of providing choice and control through a personal media device includes providing consumers with the option of selecting media based on metadata.

13. The method of delivering media to consumers as claimed in claim 1, wherein the step of providing choice and control through a personal media device includes providing consumers with the option of selecting news or events related to the selected media.

14. The method of delivering media to consumers as claimed in claim 1, wherein the step of providing choice and control through a personal media device includes providing consumers with the option of selecting merchandise related to the selected media and then providing a means for the consumer to automatically purchase the merchandise

15. The method of delivering media to consumers as claimed in claim 1, wherein the step of providing choice and control through a personal media device includes providing the consumer with the option of creating, updating, and organizing lists of favorite media.

16. The method of delivering media to consumers as claimed in claim 1, wherein the step of providing choice and control through a personal media device includes providing the consumer with a message board that is operable to allow the consumer to communicate with other consumers that are on the system and further allow the consumer to transmit personally suggested media to fellow users on the system.

17. The method as claimed in claim 1, wherein the media includes any multimedia product.

18. The method as claimed in claim 1, wherein the media is fully streamed to a personal media device from a personal media services server.

19. The method as claimed in claim 1, wherein the media is streamed to a personal media device from the combined resources of a personal media services server and from a partial copy of the media locally stored on the personal media device.

20. The method as claimed in claim 1, wherein the media can be streamed to a personal media device from a full copy of the media locally stored on the personal media device.

21. The method of delivering media to consumers as claimed in claim 1, wherein the media supplier provides content, metadata and digital rights information.

22. The method as claimed in claim 1, wherein the media can be protected by a digital rights management system.

23. A method of making music accessible to consumers on a personal media device comprising the steps of:
giving music listeners total choice of selection and total control over playback of the music through a personal media device;
profiling music listeners and automatically storing the profiled data;
providing media suppliers with a targeting system that directs messages or products to, and provides reporting on, a particular consumer group; and
providing media suppliers with operational efficiency opportunities through the targeting system.

24. A media system comprising:
a management server system that includes a media management server, a message management server, a channel management server, and a catalog management server, each management server being operable to be maintained by a supplier;
a database for each management server connected to the management server system, the database houses information for each supplier;
a personal media services server that is in communication with each database;
a data warehouse in communication with the personal media services server;
a tracking database in communication with the personal media services server;
an interface between the personal media services server and a personal media device for transmitting media to a consumer;
personal media device having an output means for a consumer to observe the received media.

25. The media system as claimed in claim 24, further comprising a targeting and reporting function that communicates with the personal media services server.

26. The media system as claimed in claim 24, further comprising a means for generating reports from the databases or data warehouses.

27. The media system as claimed in claim 24, wherein the personal media device is comprised of a consumer interface by which data to the personal media service server can be transmitted and received and the personal media device further includes media playback capabilities.

28. The media system as claimed in claim 24, wherein the interface between the personal media services server and a personal media device is a wireless network.

29. The media system as claimed in claim 24, wherein the interface between the personal media services server and a personal media device is a data network such as the Internet.

30. The media system as claimed in claim 24, further comprising a subscriber database that is in communication with the personal media services server.

31. A media system that allows a consumer to have total choice and control over the media comprising:
a data center containing product databases, tracking and subscriber databases, and a data warehouse;
a supplier system for maintaining the product databases, the supplier system including management servers;
a consumer media device that is operable to exchange data from the data center by interacting with the product databases through a personal media services server, whereby consumers provide behavioral and preferential feedback to the tracking and subscriber databases which in turn updates the data warehouse; and
a targeting and reporting function for providing information to the supplier system.
